(19) United States
(12) Patent Application Publication
(10) Pub. No.: US 2007/0096858 A1
(43) Pub. Date: May 3, 2007

(54) Electromagnetic coil

(75) Inventor: Tseng-Hai Li, Jhubei City (TW)

Correspondence Address: John S. Egbert;Egbert Law Offices, 7th Floor, 412 Main Street, Houston, TX, 77002, US

(73) Assignee: YIH SHIN NANOTECH CORPORATION, Hsinchu City (TW)

(21) Appl. No.: 11/265,841

(22) Filed: Nov. 3, 2005

(51) Int. Cl. H01F 21/02

(52) U.S. Cl. 336/15

(57) ABSTRACT

An electromagnetic coil is formed by spiraling a plate-like wire cluster. The plate-like wire cluster includes a plurality of conductive lines, and a normal direction of a plane of the long sides of the plate-like wire cluster in the cross-sectional view is approximately parallel to the spirally forward direction of the plate-like wire cluster. In other words, a normal direction of a wider side of the plate-like wire cluster in the cross-sectional view is approximately parallel to the spirally forward direction of the plate-like wire cluster. The plurality of conductive lines can be disposed and connected in a row to form the plate-like wire cluster. If the cross-sections of the conductive lines are rectangular, every pair of adjoining conductive lines is contacted by the long sides of the cross-sections of the conductive lines to form the plate-like wire cluster.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention is related to an electromagnetic coil, more specifically to an electromagnetic coil with a high intensity magnetic field.

### BACKGROUND OF THE INVENTION

According to electromagnetic theory, when a current flows through a solenoid, a magnetic field will be generated in the spiral coils and stretch outward. The direction of the magnetic field is dependent upon the direction of the current (Ampere's Law). Given a larger current or more spiral coils, the generated magnetic field will be larger, and the magnetic density is directly proportional to the number of the spiral coils.

As shown in FIG. 1, the magnetic field can be enhanced by increasing the number of spiral coils. A copper wire 11 spirals upward and then downward with a view to increasing the number of the spiral coils, thereby forming a coil 10. The current flowing through the coil 10 is dependent on applying voltages to the electrodes 12 connected to the two ends of the copper wire 111 and the load of copper wire 11 itself. The increase of spiral coils results in a higher resistance of copper wire 11, i.e., the increase of the so-called load, and as a result the current flowing therein will decrease. Accordingly, although the increase of the spiral coils would increase the magnetic density, the intensity of the magnetic field is not significantly beneficial.

Referring to FIG. 2, an electromagnetic coil 20 is formed by spiraling a plate-like wire 21, and the two ends of the plate-like wire 21 are equipped with electrodes 22. The plate-like wire 21 bends on the short side in terms of the cross-sectional view, and the cross-sectional area increases significantly in comparison with that of a traditional copper wire. Consequently, the load of the wire 21 is relatively low, so that the intensity of the magnetic field will increase. However, because the inner and outer radiuses are differentiated a lot, the wire 21 needs a large force to bend it, so the manufacturing will be more difficult. Moreover, the inner rim and outer rim of the plate-like wire 21 need to withstand large residual stresses in compression and tension, respectively, so that the wire 21 may be broken on condition that the force exceeds the yielding point of the material.

The plate-like wire can also be made by casting. However, the manufacturing for a mold is costly and the mold design is limited due to the consideration of size and mold flow, therefore a large plate-like electromagnetic coil is hard to make.

Obviously, it is important to produce a large electromagnetic coil with low load for the application of large motors or other appliances.

### BRIEF SUMMARY OF THE INVENTION

The objective of the present invention is to provide an electromagnetic coil with low load, whereby the intensity of the magnetic field can be increased so as to comply with the requirements of making a large electromagnetic coil.

In order to achieve the above objective, an electromagnetic coil formed by spiraling a plate-like wire cluster is disclosed. The plate-like wire cluster is constituted of a plurality of conductive lines, and the normal direction of the plane constituted of the long sides of the plate-like wire cluster on the cross-sectional view is approximately parallel to the forward direction of the spiral plate-like wire cluster, i.e., the axial direction of the spiral plate-like wire cluster. In other words, the normal direction of the wider surface of the plate-like wire cluster is approximately parallel to the forward direction of the spiral plate-like wire cluster.

The plurality of conductive lines could be disposed in a row to form the plate-like wire cluster. If the cross-section of the conductive line is rectangular, the long sides of the cross-sections of every pair of adjoining conductive lines are contacted to form the plate-like wire cluster.

When the plate-like wire cluster spirals, the discrepancy of the inner and outer radiuses of each conductive line is slight. In addition, each conductive line is substantially independent, so that even in the circumstance of bending with a large angle, some offsets between two adjoining conductive lines are allowed, thereby making the manufacturing easier.

In comparison with the traditional electromagnetic coil, the plate-like wire is replaced with the plate-like wire cluster and the cross-sectional area of the plate-like wire cluster is substantially equivalent to that of the plate-like wire; thus, the plate-like wire cluster can also provide a large current.

Moreover, to avoid the high heat generated due to the large current, the conductive lines can be replaced by hollow conductive tubes in which cooler flows inside, so as to achieve superior heat dissipation efficiency.

In the case of the use of conductive tubes, it is better to spiral in circles so the possible strain caused by the stress of spiraling is accounted for.

### BRIEF DESCRIPTION OF THE SEVERAL VIEWS OF THE DRAWINGS

FIG. 1 is a perspective view illustrating a known electromagnetic coil.

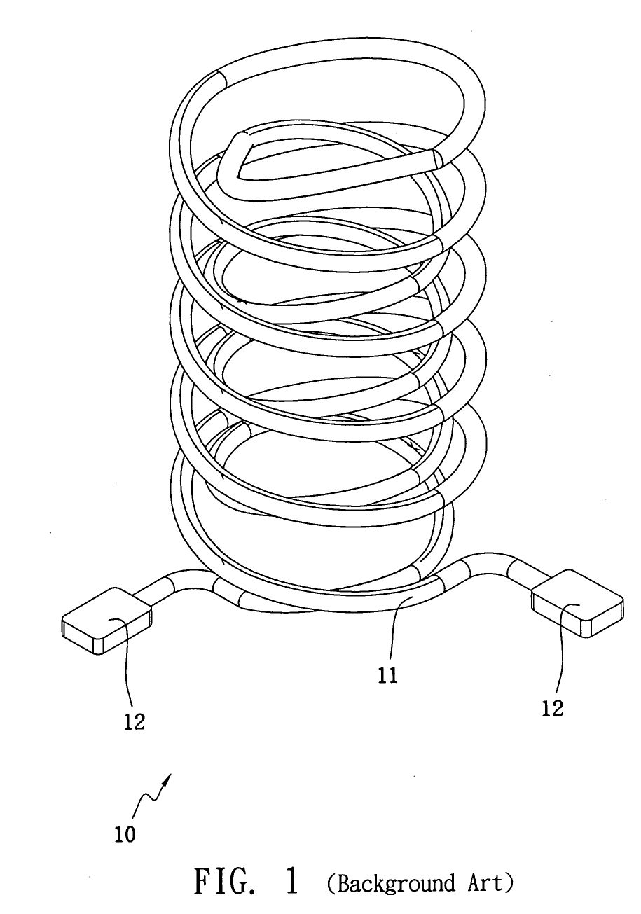

FIG. 2 is a perspective view illustrating another known electromagnetic coil.

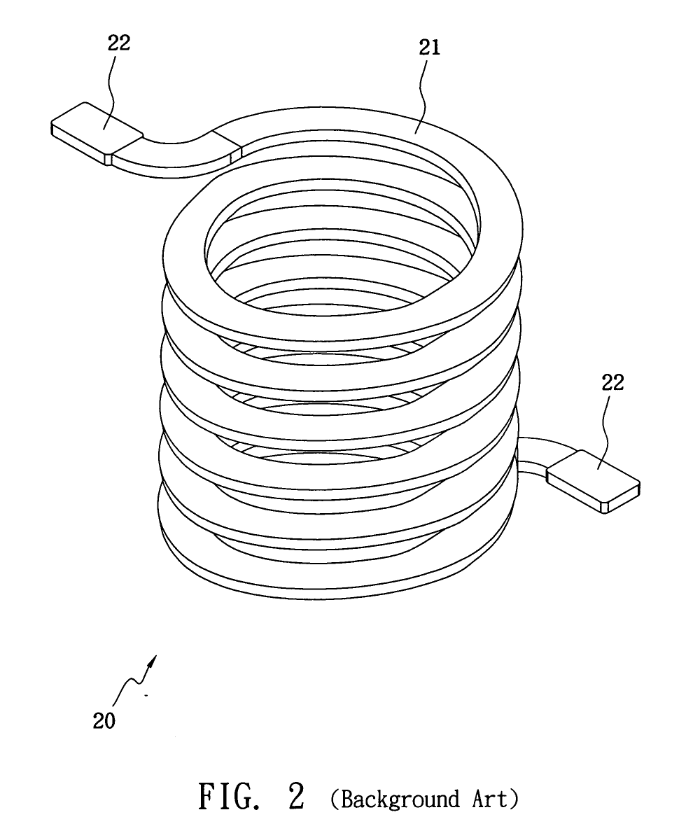

FIGS. 3 and 4 are perspective views illustrating the electromagnetic coil of the first embodiment in accordance with the present invention.

FIG. 5 is a cross-sectional view of the electromagnetic coil in accordance with the present invention.

FIG. 6 is another cross-sectional view of the electromagnetic coil in accordance with the present invention.

FIG. 7 is a perspective view illustrating the electromagnetic coil of the second embodiment in accordance with the present invention.

FIG. 8 is the cross-sectional view along line 2-2 in FIG. 7.

FIG. 9 is another perspective view illustrating the electromagnetic coil of the third embodiment in accordance with the present invention.

FIG. 10 is the cross-sectional view along line 3-3 in FIG. 9.

### DETAILED DESCRIPTION OF THE INVENTION

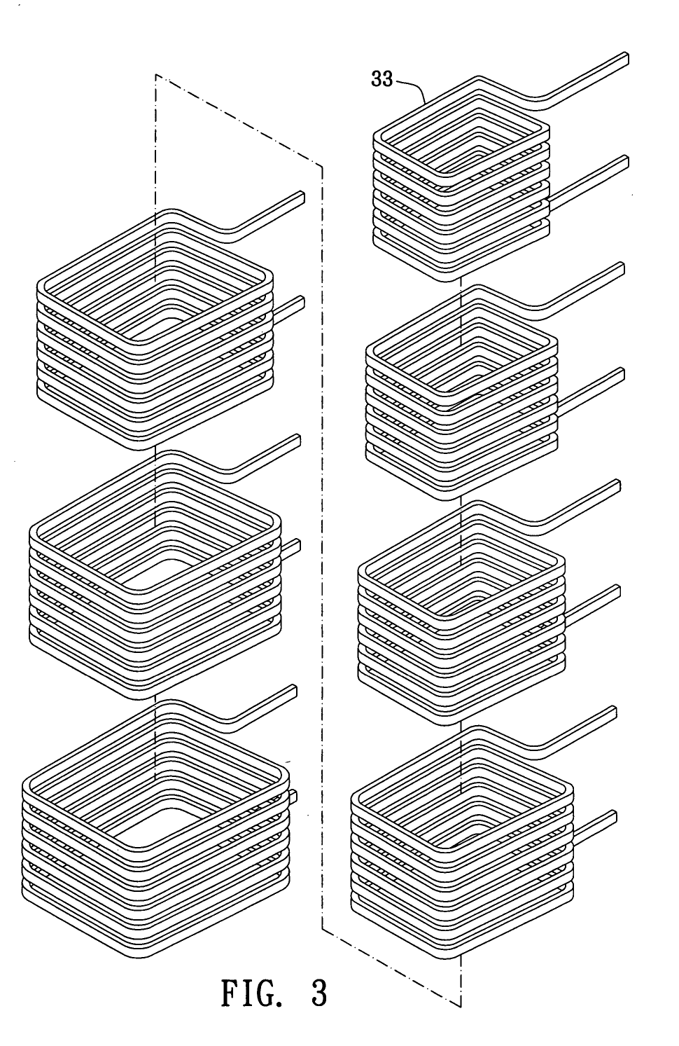

FIGS. 3 and 4 illustrate the exploded view and assembly diagram of the electromagnetic coil in accordance with the present invention. An electromagnetic coil 30 is formed by spiraling a plate-like wire cluster 31, and the plate-like wire cluster 31 including a plurality of conductive lines 33 spirals upward and bends on the short side in terms of the cross-section thereof. The adjoining conductive lines 33 can be either soldered or tightly pressed to make electrical conduction therebetween. The two ends of the plate-like wire cluster 31 are connected to two electrodes 32 in order to connect to an electrical power source. The electromagnetic coil 30 generates a magnetic field approximately parallel to the forward direction of the spiral plate-like wire cluster 31 as the dotted lines shown in FIG. 4.

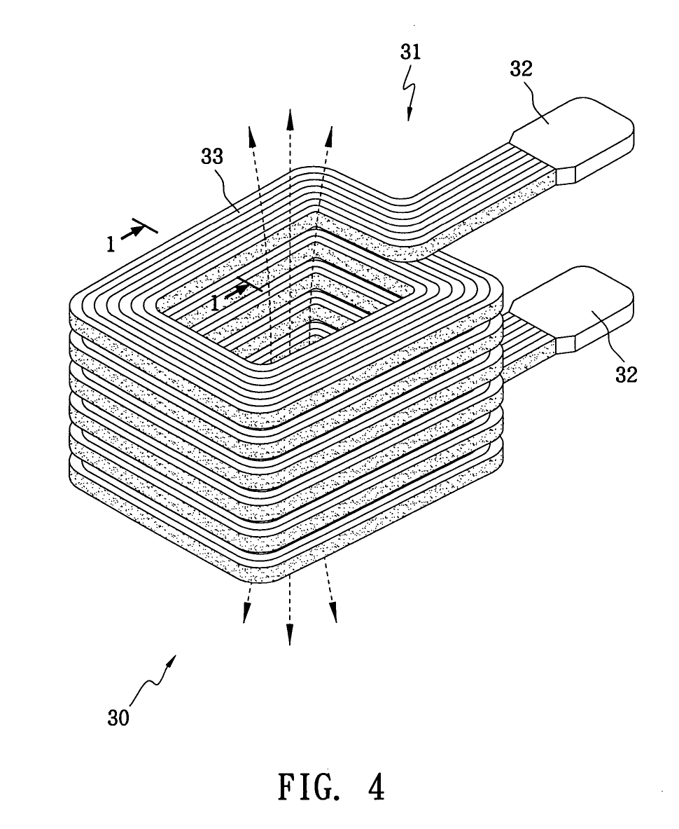

FIG. 5 illustrates the cross-sectional view of line 1-1 in FIG. 4 to show the constitution of the plate-like wire cluster 31. The cross-section of the plate-like wire cluster 31 is rectangular; the normal direction of the plane of the long side 320 is approximately parallel to the spirally forward direction of the plate-like wire cluster 31, i.e., parallel to the direction of the magnetic field generated by the electromagnetic coil 30. The short side 321 of the rectangular cross-section is approximately perpendicular to the long side 320, so that the normal direction of the plane of the short side is approximately perpendicular to the spirally forward direction of the plate-like wire cluster, i.e., perpendicular to the direction of the magnetic field generated by the electromagnetic coil 30.

The plate-like wire cluster 31 can be constituted of seven copper wires 311, i.e., conductive lines 33, connected in a row along the long side direction of the cross-section of the plate-like wire cluster 31. In practice, five to fifteen copper wires 311 are preferable. For each copper wire 311, the cross-section is approximately square, so that the manufacturing difficulty caused by a large discrepancy between inner and outer radiuses of the copper wire 311 will not occur.

In manufacturing, one end of the seven copper wires 311 can be first soldered to one of the electrodes 32, and the other end is soldered to the other electrode 32 after the seven copper wires 311 are spiraled. As a result, the lengths of the copper wires 311 are adjustable so as to comply with the requirements of the longer outer spiral copper wire 311 and shorter inner spiral copper wire 311, and especially for the case of a large number of the copper wires 311. In contrast, if only few copper wires 311 are in use, or the lengths of the inner and outer copper wires are not much different, the two ends of the copper wires 311 can be soldered to the two electrodes 32 first before the wires 311 spiral.

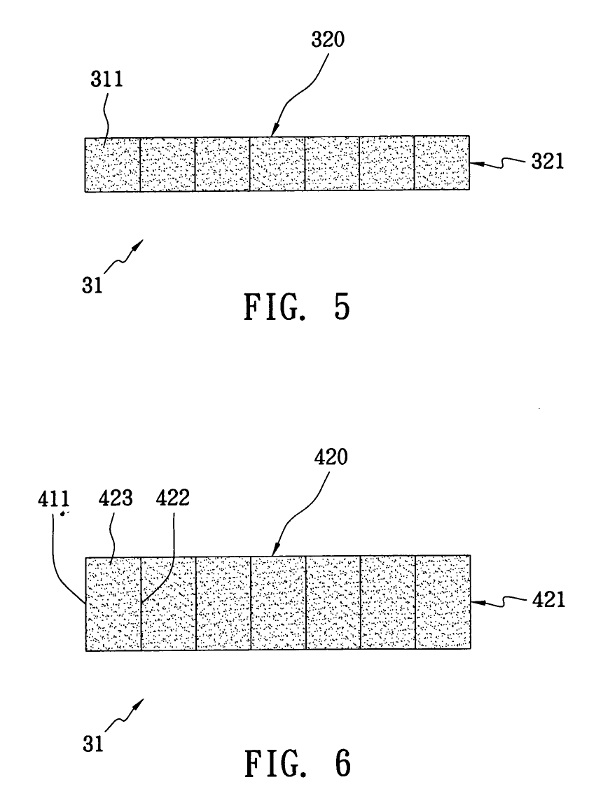

FIG. 6 illustrates the cross-sectional view of another embodiment of the plate-like wire cluster 31. The plate-like wire cluster 31 comprises seven rectangular copper wires 411 disposed in a row, and the copper wires 411 are positioned vertically. Consequently, the long sides 422 of cross-sections of the copper wires 411 are parallel to a short side 421 of the cross-section of the plate-like wire cluster 31, and the short sides 423 of the seven copper wires 411 constitute a long side 420 of the plate-like wire cluster 31. As a result, the difference between the inner and outer radiuses of the plate-like wire cluster 31 while spiraling is minimized, thereby making manufacturing easier and decreasing residual stress as well. In this embodiment, the long side 422 of the copper wire 411 is between 4 to 6 millimeters (mm) whereas the short side 423 thereof is between 1 to 3 mm.

The copper wires 311 and 411 can be replaced by other conductive lines made of other metals or conductive materials, and the number of the wires depends on what is desired.

Referring to FIG. 4 again, the plate-like wire cluster 31 can be spiraled as a rectangle to form the electromagnetic coil 30. In such design, an over-current can be avoided as a result of the increase of the impedance resulting from the bending parts of the wire cluster 31, so that it is more applicable in practice.

When the plate-like wire cluster 31 spirals completely, it can be wrapped by an insulation tape (not shown), and only the electrodes 32 are exposed for connection to a power source. Therefore, the plate-like wire cluster 31 is insulated and constrained to avoid deformation.

The comparison of the electromagnetic coil of the present invention and the two known electromagnetic coils is summarized in Table 1. The electromagnetic coil of the present invention has a high intensity magnetic field and is easily manufactured, and a mold is not needed to manufacture the electromagnetic coil in accordance with the present invention, so the cost can be reduced and a large electromagnetic coil can be fabricated.

TABLE 1

| | | | The intensity of | |
|---|---|---|---|---|
| | Load | Current | magnetic field | Manufacture |
| Copper wire | Large | Small | Small | Easy |
| spiral upward | | | | |
| and downward | | | | |
| Plate wire | Small | Large | Large | Difficult |

Although the above-mentioned electromagnetic coil has the advantages of easy manufacturing and large current loading, if used in a high temperature environment or a place of inferior heat dissipation, heat dissipation may be an issue.

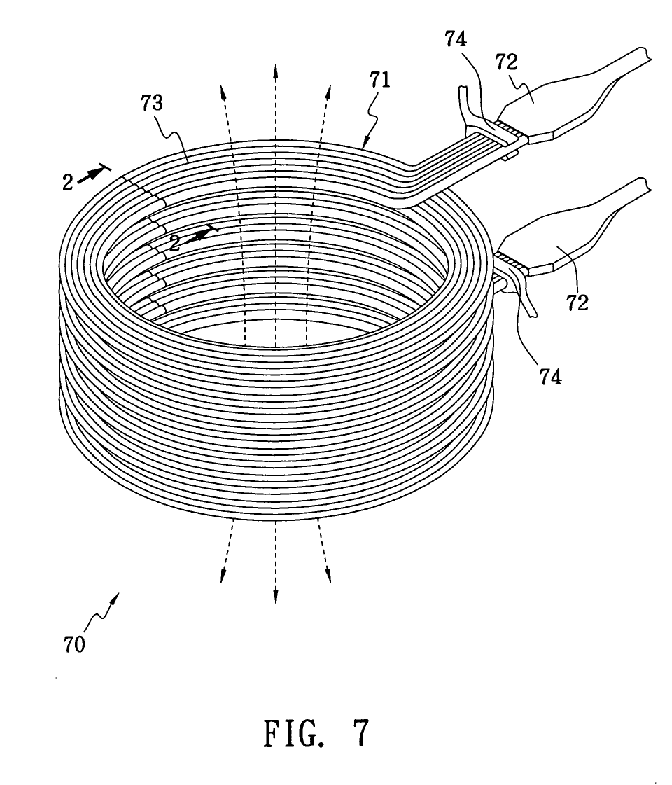

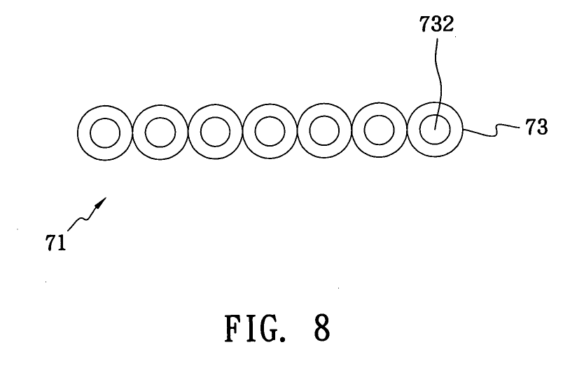

FIG. 7 illustrates the electromagnetic coil of another embodiment of the present invention, and FIG. 8 is the cross-sectional view of line 2-2. This kind of electromagnetic coil has superior heat dissipation efficiency and therefore is suitable to be used in high temperature or inferior heat dissipation environments. An electromagnetic coil 70 is formed by spiraling a plate-like wire cluster 71, and the plate-like wire cluster 71 comprises a plurality of conductive tubes 73 spiraling upwards, wherein the plurality of conductive tubes 73 can be soldered or pressed to make the electrical conduction. The two ends of the plate-like wire cluster 71 are connected to two cooler connectors 72 to allow cooler to flow through the hollow interior 732 of the conductive tube 73 for cooling the plate-like wire cluster 71. Furthermore, the two ends of the plate-like wire cluster 71 are connected to two electrodes 74 in order to connect to an electrical power source. The conductive tube 73 can be made of copper, which has the advantages of material availability and low cost. The electromagnetic coil 70 generates a magnetic field approximately parallel to the spirally forward direction of the plate-like wire cluster 71 as the dotted line shown in FIG. 7. Because the conductive tubes 73 are hollow, if the conductive tubes 73 spiral in the form of a rectangle as shown in FIG. 4, the conductive tubes 73 may not be as strong as a solid conductive line, and the bending portions of the conductive tubes 73 may be deformed owing to uneven stresses on the inside and the outside of the tubes 73. Therefore, the wire cluster 71 spiraling as a circle can avoid deformation and allow the cooler to flow steadily and freely so as to increase the cooling efficiency.

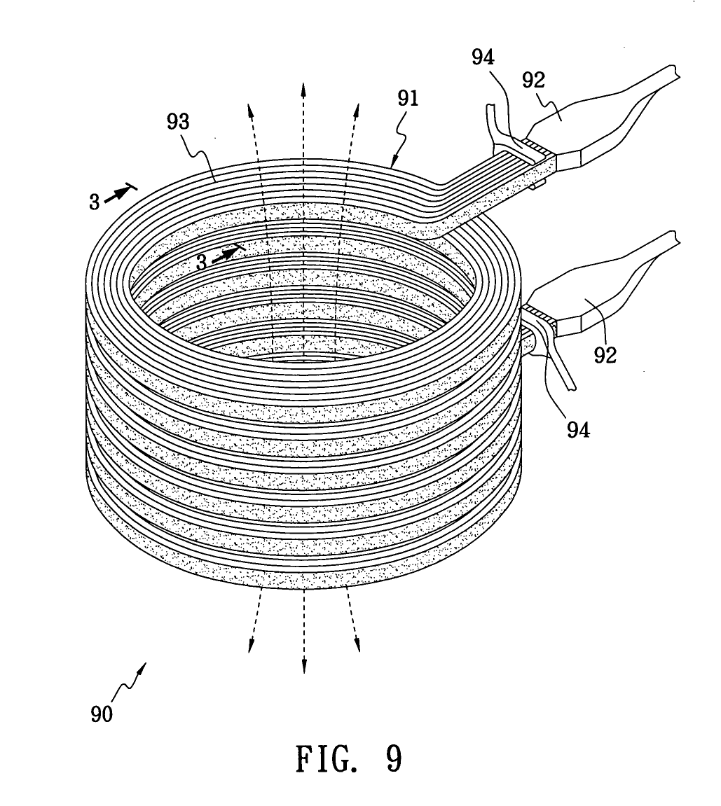

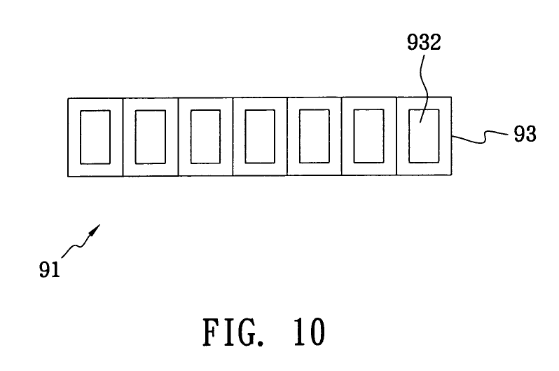

The cross-section of the conductive tube is not limited to a round shape; a rectangular cross-section can be employed as well. As shown in FIGS. 9 and 10, FIG. 10 is the cross-sectional view of line 3-3 in FIG. 9, an electromagnetic coil 90 is formed by spiraling a plate-like wire cluster 91, and the plate-like wire cluster 91 comprises a plurality of conductive tubes 93 spiraling upwards. The two ends of the plate-like wire cluster 91 are connected to two cooler connectors 92 to allow cooler to flow through the hollow interior 932 of the conductive tube 93 for cooling the plate-like wire cluster 91. Furthermore, the two ends of the plate-like wire cluster 91 are connected to two electrodes 94 in order to connect to an electrical power source. As compared to FIG. 8, the conductive tube 93 is rectangular in the cross-sectional view, and spirals as a circle to avoid deformation or internal stress.

The above-described embodiments of the present invention are intended to be illustrative only. Numerous alternative embodiments may be devised by those skilled in the art without departing from the scope of the following claims.

I claim:

1. An electromagnetic coil, comprising:
a spiral plate-like wire cluster comprising a plurality of conductive lines, wherein a normal direction of a plane comprised of long sides of cross-sections of the plate-like wire cluster is substantially parallel to a spirally forward direction of the plate-like wire cluster.

2. The electromagnetic coil in accordance with claim 1, wherein the plurality of conductive lines are disposed in a row along the long side direction of a cross-section of the plate-like wire cluster.

3. The electromagnetic coil in accordance with claim 1, wherein the conductive lines have rectangular cross-sections.

4. The electromagnetic coil in accordance with claim 3, wherein adjoining conductive lines are contacted by long sides of the cross-sections thereof.

5. The electromagnetic coil in accordance with claim 4, wherein the long sides of the rectangular cross-sections are substantially parallel to the spirally forward direction of the plate-like wire cluster.

6. The electromagnetic coil in accordance with claim 1, further comprising:
two electrodes soldered to two ends of the plate-like wire cluster.

7. The electromagnetic coil in accordance with claim 1, wherein the plate-like wire cluster spirals as a rectangle.

8. The electromagnetic coil in accordance with claim 1, further comprising:
an insulation layer wrapping the plate-like wire cluster.

9. The electromagnetic coil in accordance with claim 1, wherein the conductive lines are in the form of conductive tubes.

10. The electromagnetic coil in accordance with claim 9, wherein the plate-like wire cluster spirals as a circle.

11. The electromagnetic coil in accordance with claim 9, wherein the conductive tubes are round tubes.

12. The electromagnetic coil in accordance with claim 9, wherein the conductive tubes allow cooler to flow inside.

13. An electromagnetic coil, comprising:
a plurality of adjoining conductive lines, each conductive line bending on a long side of a cross-section thereof and spiraling upward; and
two electrodes soldered to every pair of ends of the plurality of conductive lines.

14. The electromagnetic coil in accordance with claim 13, wherein every pair of adjoining conductive lines is soldered.

15. The electromagnetic coil in accordance with claim 13, wherein the plurality of the conductive lines spirals is in the form of a rectangle.

16. The electromagnetic coil in accordance with claim 13, wherein the number of the conductive lines is between 5 and 15.

17. The electromagnetic coil in accordance with claim 13, wherein the conductive lines are in the form of conductive tubes.

18. The electromagnetic coil in accordance with claim 17, further comprising:
two cooler connectors connected to ends of the conductive tubes, allowing cooler to flow through the conductive tubes.

19. The electromagnetic coil in accordance with claim 17, wherein the conductive tubes are round.

20. The electromagnetic coil in accordance with claim 17, wherein the conductive tubes are rectangular.
